(19) United States
(12) Patent Application Publication
(10) Pub. No.: US 2016/0144343 A1
(43) Pub. Date: May 26, 2016

(54) CERAMSITE CATALYST CONTAINING METAL OXIDE PARTICLES AND PREPARATION METHOD AND APPLICATION THEREOF

(71) Applicant: SOUTH CHINA UNIVERSITY OF TECHNOLOGY, Guangzhou City, Guangdong Province (CN)

(72) Inventors: Xiaojun WANG, Guangzhou City (CN); Jinling XU, Guangzhou City (CN); Zhenguo CHEN, Guangzhou City (CN); Xunwen GUO, Guangzhou City (CN); Yaozhong HE, Guangzhou City (CN); Xiaoyang GU, Guangzhou City (CN)

(73) Assignee: SOUTH CHINA UNIVERSITY OF TECHNOLOGY, Guangzhou City, Guangdong Province (CN)

(21) Appl. No.: 14/901,527

(22) PCT Filed: Dec. 20, 2013
(86) PCT No.: PCT/CN2013/090018

§ 371 Date: Dec. 28, 2015

(30) Foreign Application Priority Data
Jun. 28, 2013 (CN) 201310268105.0

(51) Int. Cl. B01J 21/16; C02F 1/78; B01J 37/08; B01J 23/889; B01J 37/04

(52) U.S. Cl. CPC B01J 21/16; B01J 23/8892; B01J 37/04; B01J 37/08; C02F 1/78

(57) ABSTRACT

The invention belongs to the technical field of preparation of a ceramsite catalyst and discloses a ceramsite catalyst containing metal oxide particles and a preparation method and application thereof. The preparation method including the following specific steps of: dissolving a metal salt with an ozone catalytic activity in water to obtain a metal salt solution; mixing the metal salt solution with a ceramsite raw material to prepare a ceramsite embryoid body; and sintering the ceramsite embryoid body at a high temperature to obtain the ceramsite catalyst containing metal oxide particles. The ceramsite catalyst containing metal oxide particles of the invention can be repeatedly used, so that secondary pollution is reduced; and with the same ozone input quantity, by adding the ceramsite catalyst containing metal oxide particles of the present invention, the efficiency of water treatment through ozone oxidization can be increased by 41.35%.

### TECHNICAL FIELD

The present invention belongs to the technical field of preparation of a ceramsite catalyst, particularly relates to a ceramsite catalyst containing metal oxide particles and a preparation method and application thereof.

### BACKGROUND ART

Ozone has an extremely strong oxidation property, and its oxidizing ability is second only to fluorine, and higher than chlorine and potassium permanganate. Based on the strong oxidizability of ozone, and spontaneous decomposition in water can be in a short time and there is no secondary pollution, ozone is an ideal green oxidant for water treatment.

Presently, ozone technology has been applied in many aspects of the field of water treatment. Ozone not only has a very strong disinfection and sterilization effect, but also can oxidise and remove organic substances in water, particularly, waste water, after subjected to a conventional secondary biochemical treatment, still has a small quantity of organic substances which are difficult to be biodegraded, if ozone oxidation is used to perform an advanced treatment on this waste water, it is relatively thorough and a relatively few by-products are generated. Moreover, when chlorine gas or sodium hypochlorite is used as a disinfectant and antioxidant in the traditional water treatment technology, some poisonous and harmful disinfection by-products will be generated, such as organic halides like trichloromethane and so on, many research reports prove that the organic halides have carcinogenic, teratogenic and mutagenic effects.

The key of the good or bad effect of using the ozone oxidation technique is the oxidizing ability of ozone and the usage amount of the ozone. Catalyzing the ozone, increasing the oxidation efficiency of the ozone, making the oxidizing ability thereof increase, thus decreasing the cost of the advanced waste treatment, are hot pints for application research of ozone currently. Currently, ozone catalyst reported in literature is mainly homogeneous phase, i.e., the catalyst is formulated into a solution, and added into the waste water, then ozone is introduced to take place a catalytic reaction, the catalyst being present in the form of ionic state. Although this kind of liquid catalyst can increase the oxidizing ability of ozone, defects such as the catalyst cannot be reused, is easy to cause secondary pollution and increases the difficulty of the subsequent processing, etc. are still present. Thus, a solid catalyst is prepared, enabling the catalyst to have a better catalytic action on the oxidation action of ozone in the waste water, during the water treatment, the solid catalyst always retains in the ozone catalytic reactor to play a role of catalytic oxidation, no subsequent separation measures being required, and the solid catalyst will have its actual application value.

Currently, for the preparation of heterogeneous ozone catalyst, the used method is as follows: one or several of metal nitrates or sulfates with a catalytic activity are compounded in a certain ratio and dissolved in water, then a carrier is added, an alkaline substance is added to make these metal salts form a hydroxide precipitate. Then stirring and mixing, washing and filtering the carrier, finally, baking to prepare; since this kind of preparation method is to make the catalyst adhere on the carrier surface, during the preparation, there are plenty of reaction by-products, meanwhile, plenty of catalysts which cannot be adhered on the carrier surface need to be removed by washing, resulting in relatively large waste. In addition, since the catalyst is adhered on the carrier surface by baking, its adhesive strength is relatively poor, after repeated use, the wastage rate of the catalyst is relatively large, and since steps of production method of this kind are tedious, it is harder to achieve a large-scale industrial production.

WANG Xiaojun et al (ZL 200710032553.5) prepare a ceramsite catalyst: firstly, pulverized fuel ash, kaolin and an expanding agent are used as raw materials for producing the ceramsite to prepare the ceramsite raw material nucleus with a grain size of 1-2.5 mm through a sugar-coating preparing machine; before baking the raw material nucleus, in the raw material for preparing the ceramsite, one or several of the metal oxides such as Mn(II), Mn(IV), Fe(III), Co(II), Co(IV), Ti(II) oxides are added and compounded, both of them are mixed and then used as a new raw material and added into the sugar-coating preparing machine, making same uniformly adhere on the surface of the original ceramsite raw material nucleus, baking so as to prepare the ceramsite catalyst used for ozone catalytic oxidation.

However, since the metal oxides are used, particles of these oxides are limited by mechanical grinding, the particles are often relatively coarse, affecting the catalytic oxidation effect thereof.

### CONTENTS OF THE INVENTION

In order to overcome the above-mentioned shortcomings and defects of the prior art, the primary goal of the present invention consists in providing a preparation method for a ceramsite catalyst containing metal oxide particles. The preparation method prepares the ceramsite catalyst used for ozone catalytic oxidation by adding a component with a catalytic activity as a production raw materials thereof during the production of the ceramsite, increasing the oxidizing ability of the ozone so as to increase the ability to remove the organic matter which is difficult to degrade in water, thus decreasing the operating cost of water treatment through ozone oxidation.

Another goal of the present invention consists in providing the ceramsite catalyst containing metal oxide particles prepared by the above-mentioned method.

A further goal of the present invention consists in providing an use of the above-mentioned ceramsite catalyst containing metal oxide particles in the water treatment.

The goals of the present invention are achieved by the following scheme:

A preparation method for a ceramsite catalyst containing metal oxide particles, comprising the following specific steps:

dissolving a metal salt with an ozone catalytic activity in water to obtain a metal salt solution; mixing the metal salt solution with a ceramsite raw material to prepare a ceramsite embryoid body; and sintering the ceramsite embryoid body at a high temperature to obtain the ceramsite catalyst containing metal oxide particles.

It can also be that: before mixing the metal salt solution with a ceramsite raw material, taking a part of the ceramsite raw material to prepare ceramsite raw material nucleuses through a sugar-coating preparing machine, then mixing the metal salt solution with the remaining ceramsite raw material and then adding same into the above-mentioned ceramsite raw material nucleuses to prepare a ceramsite embryoid body, and sintering the ceramsite embryoid body at a high temperature to obtain the ceramsite catalyst containing metal oxide particles.

Said metal salt with an ozone catalytic activity refers to at least one of a metal sulfate and a metal nitrate.

Preferably, it is at least one of manganese sulfate, cobalt sulfate, manganese nitrate and cobalt nitrate, etc.

said ceramsite raw material refers to at least one of pulverized fuel ash, kaolinite and an expanding agent.

The pulverized fuel ash, kaolinite and expanding agent used are all raw materials commonly used for producing the ceramsite.

The concentration of said metal salt solution is 2-40 wt %.

The ratio of the amount of the used metal salt with an ozone catalytic activity to the mass of the ceramsite raw material is (0.004-0.1):1.

Said high temperature refers to a temperature of 1100° C.-1250° C.

The grain size of said ceramsite embryoid body is 3-8 mm.

Said ceramsite embryoid body prepared refers to a ceramsite embryoid body prepared through the sugar-coating preparing machine.

The grain size of said ceramsite raw material nucleus is 1-2.5 mm.

The ceramsite catalyst containing metal oxide particles prepared by the above-mentioned method.

An active ingredient of said ceramsite catalyst containing metal oxide particles is at least one of MnO₂, CoO and Co₃O₄, a carrier being the ceramsite. When a catalytic reaction is carried out, the catalyst not only plays a role of increasing the oxidizing ability of ozone, but also because of being solid particles, forms a heterogeneous phase to catalyze the oxidation reaction of the ozone, thus can be reused, secondary pollution is reduced and it is not easy to loss into waste water to cause the secondary pollution.

An use of the above-mentioned ceramsite catalyst containing metal oxide particles in the water treatment.

The ceramsite catalyst containing metal oxide particles both can be used to treat water alone and can be used with other methods. Ozone, after subjected to catalysis through the catalyst, can remove the organic contaminants in water more effectively, its oxidizing ability is obviously increased, thus the added amount of ozone is decreased, saving the operating cost; by preparing the ceramsite containing the catalyst activity component in the surface layer, the utilization ratio of the catalyst can be greatly increased, the production cost of the catalyst is reduced, wastage rate of the catalyst is reduced and the secondary pollution is prevented.

The mechanism of the present invention is as follows:

The raw materials for producing the ceramsite are all powdery raw materials, during the production process, they have to form a ceramsite preform body by mixing with water and form the ceramsite through sintering. In the present invention, a metal salt with an ozone catalytic activity is dissolved in water to obtain a metal salt aqueous solution, which is used to replace the water for manufacturing the ceramsite preform body and to prepare the ceramsite preform body, and sintering the ceramsite preform body at a high temperature to obtain the ceramsite catalyst containing metal oxide particles.

The use of the metal salt solution as a binder, since its material is close, its adhesive strength is high, makes the remaining ceramsite raw material adhere on the surface of the ceramsite raw material nucleus, obtaining a ceramsite with an increased grain size.

The metal salt in the metal salt solution decomposes to a metal oxide and a gas, such as sulfur dioxide, nitrogen dioxide, etc., when the temperature is higher than 800° C., and the gas is discharged with the tail gas of the heating furnace after treated. And the metal oxide formed by the decomposition, the particles are tiny, uniformly distributed in ceramsite, increasing the utilization ratio of metal oxide active component.

In the present invention, the ceramsite preform body is formed by dissolving a metal salt in water, using same as the binder to mix with the ceramsite raw material; the metal salt decomposes to a metal oxide and a gas, such as sulfur dioxide or nitrogen dioxide, etc., at a high temperature, and the gas is discharged with the tail gas of the heating furnace after treated, furthermore, the metal oxide particles formed by the decomposition are tiny, uniformly distributed in ceramsite, increasing the utilization ratio of metal oxide active component. Since the active component of the catalyst is loaded on the ceramsite raw material nucleuses after mixing with the ceramsite raw material as an aqueous solution, and since its material is close, its adhesive strength is high, meanwhile forming by one sintering.

The present invention, relative to the prior art, has the following advantages and beneficial effects:

(1) in the present invention, the ceramsite preform body is prepared by dissolving a metal salt with an ozone catalytic activity in water and using same with the ceramsite raw material; during the high temperature sintering, the metal oxide particles obtained by the decomposition of the metal salt are tiny, uniformly distributed in ceramsite, increasing the utilization ratio of metal oxide active component and reducing the cost of production.

(2) the ceramsite catalyst prepared in the present invention can be reused, thus reducing the secondary pollution, decreasing the operating cost of the ozone oxidation, and it is more easy to achieve the large-scale industrial production.

(3) The ceramsite catalyst containing metal oxide particles of the present invention both can be used to treat water alone and can be used with other methods. Ozone, after subjected to catalysis through the catalyst, can remove the organic contaminants in water more effectively, and its oxidizing ability is obviously increased. With the same ozone input quantity, by adding the ceramsite catalyst containing metal oxide particles of the present invention, the efficiency of water treatment through ozone oxidization can be increased by 41.35%, thus the added amount of ozone is decreased, saving the operating cost; by preparing the ceramsite containing the catalyst activity component in the surface layer, the utilization ratio of the catalyst can be greatly increased, the production cost of the catalyst is reduced, wastage rate of the catalyst is reduced and the secondary pollution is prevented.

### SPECIFIC EMBODIMENTS

The present invention is further described in detail in combination with embodiments below, but the mode of execution of the present invention is not limited thereto.

### Embodiment 1

Pulverized fuel ash, kaolinite and an expanding agent are selected as the ceramsite raw materials (the above raw materials are all common powdery materials for producing ceramsite). A part of the ceramsite raw material is taken to prepare ceramsite raw material nucleuses with a particular size of 1-1.5 mm using a sugar-coating preparing machine.

Manganese sulfate and cobalt sulfate are dissolved in water to prepare a solution, wherein, the concentrations of the manganese sulfate and cobalt sulfate are 1 wt %, 1 wt %, respectively; the solution is mixed with the remaining ceramsite raw material and added into the sugar-coating preparing machine, adhering on the above-mentioned ceramsite raw material nucleuses to generate the ceramsite with a particular size of 3-4 mm, sintering the ceramsite at 1100° C.-1250° C. to prepare the ceramsite catalyst containing metal oxide particles.

The ratio of the mass of the manganese sulfate and cobalt sulfate used to the mass of the ceramsite raw material is 0.004:1.

In the advanced treatment of waste water subjected to a secondary biochemical treatment of a certain pharmaceutical chemical industry park by using ozone oxidation, the ratio of the added amount of ozone to the mass of COD is O₃:COD=(0.2-0.8):1, and COD is decreased from original 130 mg/L to 90 mg/L; adding the prepared ceramsite catalyst containing metal oxide particles above-mentioned to catalyze, with the same added amount of ozone, COD is decreased to 65 mg/L, the treatment efficiency being increased by 19.23%.

### Embodiment 2

Pulverized fuel ash, kaolinite and an expanding agent are selected as the ceramsite raw materials (the above raw materials are all common powdery materials for producing ceramsite). A part of the ceramsite raw material is taken to prepare ceramsite raw material nucleuses with a particular size of 1-1.5 mm using a sugar-coating preparing machine.

Manganese sulfate and cobalt nitrate are dissolved in water to prepare a solution, wherein, the concentrations of the manganese sulfate and cobalt nitrate are 15 wt %, 20 wt %, respectively; the solution is mixed with the remaining ceramsite raw material and added into the sugar-coating preparing machine for preparing the ceramsite raw material nucleuses above-mentioned, adhering on the above-mentioned ceramsite raw material nucleuses to generate the ceramsite with a particular size of 3-4 mm, sintering the ceramsite at 1100° C.-1250° C. to prepare the ceramsite catalyst containing metal oxide particles.

The ratio of the total mass of the manganese sulfate and cobalt nitrate used to the mass of the ceramsite raw material is 0.07:1.

In the treatment of waste water containing phenol of a certain chemical plant by using ozone oxidation, the ratio of the added amount of ozone to the mass of phenol is O₃:phenol=(0.2-1):1, and COD is decreased from original 520 mg/L to 320 mg/L; adding the prepared ceramsite catalyst containing metal oxide particles above-mentioned to catalyze, with the same added amount of ozone, COD is decreased to 105 mg/L, the treatment efficiency being increased by 41.35%.

### Embodiment 3

Pulverized fuel ash, kaolinite and an expanding agent are selected as the ceramsite raw materials (the above raw materials are all common powdery materials for producing ceramsite). A part of the ceramsite raw material is taken to prepare ceramsite raw material nucleuses with a particular size of 1-1.5 mm using a sugar-coating preparing machine.

Manganese nitrate, cobalt sulfate and manganese nitrate are dissolved in water to prepare a solution, wherein, the concentrations of the manganese sulfate, cobalt sulfate and manganese nitrate are 15 wt %, 15 wt %, 10 wt %, respectively; the solution is mixed with the remaining ceramsite raw material and added into the sugar-coating preparing machine for preparing the ceramsite raw material nucleuses above-mentioned, adhering on the above-mentioned ceramsite raw material nucleuses to generate the ceramsite with a particular size of 3-4 mm, sintering the ceramsite at 1100° C.-1250° C. to prepare the ceramsite catalyst containing metal oxide particles.

The ratio of the total mass of manganese nitrate, cobalt sulfate and manganese nitrate used to the mass of the ceramsite raw material is 0.1:1.

In the treatment of waste water of tank washing of a certain wharf by using ozone oxidation, the ratio of the added amount of ozone to the mass of COD is O₃:COD=(0.1-1):1, and COD is decreased from original 1600 mg/L to 1200 mg/L; adding the prepared ceramsite catalyst containing metal oxide particles above-mentioned to catalyze, with the same added amount of ozone, COD is decreased to 800 mg/L, the treatment efficiency being increased by 25%.

### Embodiment 4

Pulverized fuel ash, kaolinite and an expanding agent are selected as the ceramsite raw materials (the above raw materials are all common powdery materials for producing ceramsite).

Manganese sulfate and cobalt nitrate are dissolved in water to prepare a solution, wherein, the concentrations of the manganese sulfate and cobalt nitrate are 10 wt %, 10 wt %, respectively; the solution is stirred and mixed with the ceramsite raw material to prepare the ceramsite preform body with a particular size of 3-4 mm by using a sugar-coating preparing machine, sintering the ceramsite preform body at 1100° C.-1250° C. to prepare the ceramsite catalyst containing metal oxide particles.

The ratio of the total mass of the sum of the manganese sulfate and cobalt nitrate used to the mass of the ceramsite raw material is 0.04:1.

In the treatment of a certain dyeing waste water by using ozone oxidation, the ratio of the added amount of ozone to the mass of COD is O₃:COD=(0.1-1):1, and COD is decreased from original 120 mg/L to 95 mg/L; adding the prepared ceramsite catalyst containing metal oxide particles above-mentioned to catalyze, with the same added amount of ozone, COD is decreased to 70 mg/L, the treatment efficiency being increased by 21%.

In the aforementioned embodiments, the ceramsite catalyst containing metal oxide particles is added into an ozone catalytic reaction device to carry out the catalytic ozonation of organic contaminants in water. The ozone catalytic reaction device consists of a water distribution system, a catalytic reaction layer, and a tail gas absorber, wherein, the water distribution system is achieved by arranging a water distributor on the top of a filter plate; the top of the filter plate is filled with a catalytic reaction layer composed of a solid catalyst; a water outlet system is equipped with a filter screen to make the carrier having the catalyst cannot be brought out; the tail gas absorber collects the residual ozone after the reaction. The collected ozone can be used in other oxidation process; if the ozone is not recycled, the ozone is treated by a ozone tail gas destructor so as to prevent the ozone from escaping and resulting in pollution. The technological process thereof is as follows: ozone firstly passes through a gas absorber to make the gas and water uniformly mixed, then enters into the ozone catalytic reaction device, passing through the water distribution system, making the water and ozone and catalyst fully contact; then the catalyst catalyzes ozone to oxidize the contaminants in water, increasing the removal ability of ozone on contaminants, thus saving the added amount of ozone and reducing the operating cost of the water treatment.

An ozone catalytic reactor can be divided into two types: an up-flow type (water flows from bottom to top) and a down-flow type (water flows from top to bottom) according to the direction of water flow, and can be adjusted according to practical engineering.

The technological parameters of the catalytic reactor are as follows: the catalytic reaction device is full of the catalyst, reserving a protection height of 0.2-1 m on the top so as to be beneficial to the expansion of the catalyst layer when reacts in the up-flow type; after mixing, the waste water and ozone quickly enter into the catalytic reactor, the contact time with the catalyst being 5-60 min.

The material of the reactor is made of an ozone corrosion resistant material, such as stainless steel, glass, polytetrafluorethylene, etc.

The aforementioned embodiments are better modes of execution of the present invention, but the modes of execution of the present invention are not limited by the aforementioned embodiments, any other changes, modifications, replacements, combinations and simplifications made without departing from the spiritual essence and principle of the present invention all should be equivalent substitute modes and all be contained within the scope of protection of the present invention.

1. A preparation method for a ceramsite catalyst containing metal oxide particles, wherein it comprising the following specific steps of: dissolving a metal salt with an ozone catalytic activity in water to obtain a metal salt solution; mixing the metal salt solution with a ceramsite raw material to prepare a ceramsite embryoid body; and sintering the ceramsite embryoid body at a high temperature to obtain the ceramsite catalyst containing metal oxide particles.

2. A preparation method for a ceramsite catalyst containing metal oxide particles according to claim 1, wherein: before said mixing the metal salt solution with a ceramsite raw material, taking a part of the ceramsite raw material to prepare ceramsite raw material nucleuses through a sugar-coating preparing machine, then mixing the metal salt solution with the remaining ceramsite raw material and then adding same into the above-mentioned ceramsite raw material nucleuses to prepare a ceramsite embryoid body, and sintering the ceramsite embryoid body at a high temperature to obtain the ceramsite catalyst containing metal oxide particles.

3. A preparation method for a ceramsite catalyst containing metal oxide particles according to claim 1, wherein: said metal salt with an ozone catalytic activity refers to at least one of a metal sulfate and a metal nitrate; said ceramsite raw material refers to at least one of pulverized fuel ash, kaolinite and an expanding agent.

4. A preparation method for a ceramsite catalyst containing metal oxide particles according to claim 1, wherein: said metal salt with an ozone catalytic activity refers to at least one of manganese sulfate, cobalt sulfate, manganese nitrate and cobalt nitrate, etc.

5. A preparation method for a ceramsite catalyst containing metal oxide particles according to claim 1, wherein: the concentration of said metal salt solution is 2-40 wt %; the ratio of the amount of the used metal salt with an ozone catalytic activity to the mass of the ceramsite raw material is (0.004-0.1):1.

6. A preparation method for a ceramsite catalyst containing metal oxide particles according to claim 1, wherein: said high temperature refers to a temperature of 1100° C.-1250° C.; the grain size of said ceramsite embryoid body is 3-8 mm; said ceramsite embryoid body prepared refers to a ceramsite embryoid body prepared through the sugar-coating preparing machine.

7. A preparation method for a ceramsite catalyst containing metal oxide particles according to claim 2, wherein: the grain size of said ceramsite raw material nucleuses is 1-2.5 mm.

8. A ceramsite catalyst containing metal oxide particles, wherein: it is prepared by the preparation method for a ceramsite catalyst containing metal oxide particles of claim 1.

9. A ceramsite catalyst containing metal oxide particles according to claim 8, wherein: an active ingredient of said ceramsite catalyst containing metal oxide particles is at least one of MnO₂, CoO and Co₃O₄, a carrier being the ceramsite.

10. A water treatment method comprising:
applying a ceramsite catalyst containing metal oxide particles according to claim 1 in water treatment.
